(19) United States
(12) Patent Application Publication
(10) Pub. No.: US 2010/0109262 A1
(43) Pub. Date: May 6, 2010

(54) Self-tightening drill chuck

(75) Inventor: Qing-Zi Yu, Wendeng City (TW)

Correspondence Address: SALLY CHANG, 7F, NO. 3, ALLEY 32, SEC. 6 CHUNG-HSIAO EAST RD., TAIPEI, TAIWAN, R.O.C. 115, TAIPEI, 115, TW

(73) Assignees: Xin-Li Chen; Qing-Zi Yu; Po-Ping Yeung

(21) Appl. No.: 12/453,399

(22) Filed: May 11, 2009

(30) Foreign Application Priority Data
Oct. 30, 2008 (CN) 200820136989.9

(51) Int. Cl. B23B 31/165

(52) U.S. Cl. 279/60

(57) ABSTRACT

The present invention is to provide a paint roller with tubular frame processed through less contamination process, lower material cost, light weight but durable in use. Said paint roller with tubular frame includes, at least, a tubular axle (1); a cylinder (4) at a distal end of said axle (1); and a handle (3) at a proximal end of said axle (1); characterized in that: being processed through roll mill to reel stretch said axle (1) to form bent portions (2), which further processed through stamping machine to lengthen, flatten and bend the bent portions (2), where a cross section of said bent portions (2) shown a width larger than a height shaped in an overall flattened configuration (A).

### FIELD OF THE INVENTION

The present invention relates to a self-tightening drill chuck, which can be mounted onto processing machinery as a clamping tool.

### BACKGROUND OF THE INVENTION

Milling and drill machines are commonly used as processing equipments for cutting or hole-perforating. Such tools usually require a drill chuck for clamping interchangeable drill bits of different types. A keyed chuck is a very conventional drill chuck which requires a key providing force to tighten and loosen the jaws by twisting said key. This style of chuck has features of low cost and easy to manufacture, however, the clamping force provided by human strength rising up the disengagement of the drill tips when a high torque is applied; vibration of the equipment may also cause the chuck fail to clamp the drill tip. Another type of chuck which comprises three outer-thread jaws for clamping, since threads on all three jaws must be consistent, manufacture with high precision is required, which increases the cost. Self-tightening chuck is the other type of the chuck which consists of a chuck-body, a mandrel that joints said chuck-body; a dish, engaged on bottom of said mandrel, various wedge-shaped jaws and correspondent retainers. Said concept provides good clamping force, high precision and stability. However, the yield for manufacturing wedge-shaped jaws is low and the method thereof is complicated, both factors increase the cost of manufacture. Therefore, to provide a self-tightening drill chuck with low cost and high clamping force becomes the objective of present invention.

### SUMMARY OF THE INVENTION

To solve aforementioned defects, a self-tightening drill chuck as claimed in the present invention comprises a chuck-body (1) and three jaws (2); said chuck-body (1) includes three symmetrical and angled guides (16), penetrated said chuck-body (1) rectipetaly, forming a tool-receiving hole (17) on bottom of said chuck-body (1) around an axis of rotation thereof. Each of said jaws (2) has a smooth surface and is incorporated into said guide (16) and provided sliding movability. Said drill chuck further comprises a mandrel (4) and a screw nut (3). The upper portion of said mandrel (4) is engaged with a counterbore, a screwed hole or a shaft which pairs up with a drive shaft of a device that equips said drill chuck. A connecting hole (18) which pairs up with an external diameter of a bottom end of said mandrel (4), is set about the axis of rotation on the upper end of said chuck-body (1). The bottom portion of said mandrel (4) is movably coupled with said connecting hole (18); a retaining mechanism is installed between the chuck-body (1) and the mandrel (4) to avoid disengagement. A pair of threads are set around the surface of said mandrel (4) and internal surface of said screw nut (3) separately for jointing said screw nut (3) onto said mandrel (4); three grooves (31) with shape of a “T” are set on the bottom of said screw nut (3) where engaged with the upper end of said jaws (2). Each transversal section surface thereof forms an unclosed curve, and a nose which matches to said T-shaped groove (31), is set on the upper end of each jaw (2); and said nose is freely jointed therein.

The retaining mechanism consists essentially of one circular second race (41) whose transversal section is semi-spherical and disposed on the exterior of the bottom of said mandrel (4); pluralities of bearing balls (8) and one first retainer (14) which is set on the interior wall of said connecting hole (18) and corresponding to the position of said second race (41). Both transversal sections of said first race (14) and second race (41) are semi-spherical and equivalent. The diameter of each bearing ball (8) is equivalent to the diameter of first and second race (41); and said bearing balls (8) are filled into a circular spherical chamber, formed by coupling said first and second race (14,41), through a loading hole (13) and is sealed by a seal screw (12) afterward.

The drill chuck of the present invention also equips a locking mechanism which comprises an outer casing (9), a locking spring (5), a locking cap (6) and a locking nut (7). Said locking spring (5) is a disc spring having pluralities of linear slots on the exterior thereof, and a passage hole is set on the centre for accommodating a positioner which is set on upper end of said mandrel (4), and allowing the locking spring (5) couple onto the upper end of said mandrel (4). The locking cap (6) is a cylinder having an opening on a bottom end, whose internal diameter is longer than the external diameter of the upper end of said outer casing (9); a cap hole is set on top of said locking cap (6), matching the external diameter of the topper end of said mandrel (4), and pluralities of pins (61) are disposed on the bottom of said locking cap (6), along the circumference of the hole, said locking cap (6) is coupled onto said mandrel (4) and locking spring (5). The locking nut (7) is screw jointed onto the top of said mandrel (4) and placed on top of said locking cap (6). The outer casing (9) is a cylinder, having an opening on an upper end, whose internal diameter is longer than the external diameter of said nut (3) and longest diameter of said chuck-body (1). A casing passage which matching the external diameter of the bottom end of said chuck-body (1), is set on the bottom of said casing (9), about the axis of rotation. The bottom end of the chuck-body (1) is fixed securely into said casing passage. The internal diameter of the upper end of said outer casing (9) pairs up with the exterior diameter of said locking spring (5).

The advantage of aforementioned chuck is that both mandrel (4) and chuck-body (1) are freely jointed, providing self-tightening feature to the present invention. Sufficient clamping force can avoid the disengagement of the drill bit during the usage of the machine. No extra method is needed to process on the exterior of the jaw, which simplify the manufacture and lower the cost.

### BRIEF DESCRIPTION OF DRAWINGS

FIG. 1 is a sectional view of the first embodiment of the present invention.

FIG. 2 is an exploded view of FIG. 1.

FIG. 3 is a sectional view of the second embodiment of the present invention.

FIG. 4 is a sectional view of the third embodiment of the present invention.

### DETAILED DESCRIPTION OF PREFERRED EMBODIMENTS

### First Embodiment

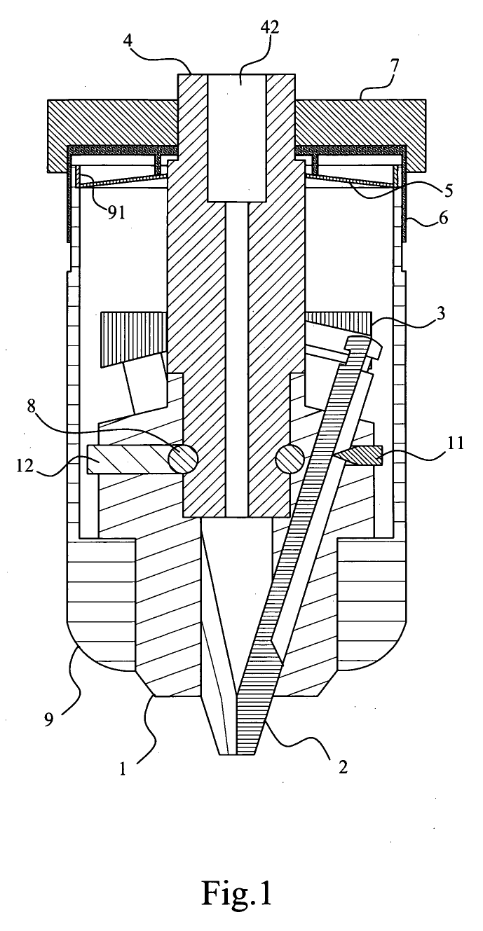

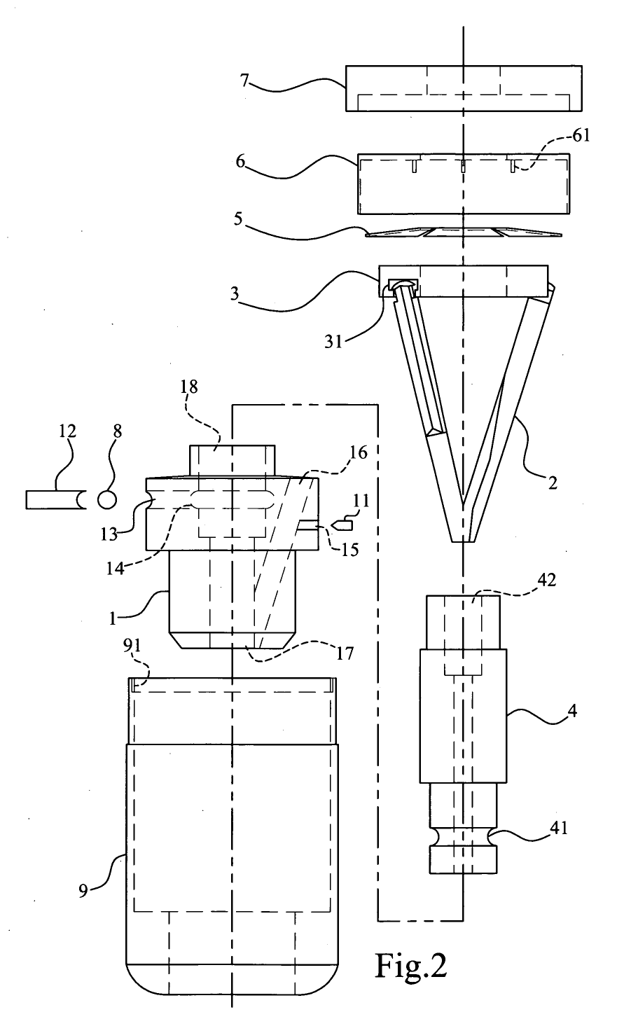

As illustrated in FIGS. 1 and 2, a self-tightening drill chuck comprises a chuck-body (1), three jaws (2), a mandrel (4), a nut (3), a locking spring (5), a locking cap (6), a locking nut (7), bearing balls (8) and an outer casing (9). Three angled guides (16) penetrate said chuck-body from top to bottom, forming a tool-receiving hole (17) on bottom of said chuck-body (1) around an axis of rotation thereof; and each of said jaws (2) is incorporated into the guide (16) and provided with sliding movability. A shaft hole (42), which pairs up with a drive shaft of a device that equips said drill chuck, is coupled on the upper end of the mandrel (4). The bottom portion of said mandrel (4) is movably attached to said connecting hole (18). A retaining mechanism is installed between the chuck-body (1) and the mandrel (4) for preventing disengagement. Said retaining mechanism consists of a circular second race (41) whose transversal section is semi-spherical and disposed around the exterior of the bottom of said mandrel (4); pluralities of bearing balls (8) and one first retainer (14) which is set on the interior wall of said connecting hole and corresponding to the position of said second race (41). Both transversal sections of said first race (14) and second race (41) are semi-spherical and equivalent; and the diameter of each bearing ball (8) is equivalent to the diameter of first and second race (41). Said bearing balls (8) are placed in a circular spherical chamber formed by said first and second race (41). The retaining mechanism of the present invention joints the chuck-body (1) and mandrel (4), also functions as a bearing, providing rotational force to the chuck body (1) and mandrel (4) with minimum friction. A pair of threads are set around the surface of said mandrel (4) and internal surface of said screw nut (3) respectively for jointing said screw nut (3) with said mandrel (4); three grooves (31) having shape of a “T” are set on the bottom of said screw nut (3) where engaged with the upper end of said jaws (2), each transversal section surface thereof forms an unclosed curve, and a T shaped nose which correspondingly matches to said T-shaped groove (31), is set on the upper end of each jaw (2); and said nose is movably jointed therein.

The locking spring (5) is a disc spring having pluralities of linear slots on the exterior thereof, and a passage hole is set on the centre for accommodating a positioner which is set on upper end of said mandrel (4), and couple the locking spring (5) onto the upper area of said mandrel (4). The locking cap (6) is a cylinder having an opening on a bottom end, whose internal diameter is longer than the external diameter of the upper end of said outer casing (9); a cap hole is set on top of said locking cap (6), matching the external diameter of the topper end of said mandrel (4), and pluralities of pins (61) are disposed on the bottom of said locking cap (6), along the circumference of the hole, said locking cap (6) is coupled onto said mandrel (4) and locking spring (5). The locking nut (7) is screw jointed onto the top of said mandrel (4) and placed on top of said locking cap (6). The outer casing (9) is a cylinder, having an opening on an upper end, whose internal diameter is longer than the external diameter of said nut (3) and longest diameter of said chuck-body (1). A casing passage which matching the external diameter of the bottom end of said chuck-body (1), is set on the bottom of said casing (9), along the axis of rotation, the bottom end of the chuck-body (1) is fixed securely into said casing passage. A locking ring (91), whose the internal diameter matches the exterior diameter of said locking spring (5) is engaged on the upper end of said outer casing (9).

To have a self-tightening drill chuck of the present invention to function, a tool such as a drill bit is inserted into the tool-receiving hole (17), rotating the outer casing (9) afterward to drive the rotation of the chuck-body (1) and mandrel (4). As all jaws (2) are incorporated into the guides (16) and the upper end of each jaw (2) is engaged into a T-shaped groove (31) set on the nut (3), the rotation of the mandrel (4) enforces the nut (3) to revolve downwardly in accordance with the thread and all jaws (2) attached to the nut (3) are moving along the guides (16). As jaws (2) moves downwardly, the space formed by the jaws (2) on the bottom end is also closing and clamping the tool which is placed into the tool-receiving hole (17) previously. When the machine is switched on, the mandrel (4) which engages with the drive shaft spins in a high velocity and the static inertia causes the nut (3), the outer casing (9) and the chuck-body (1) to rotate as the mandrel (4) spins, such force allows the jaws (2) to clamp the tool more tight. When the tool makes the contact with an object, the reaction force will also tighten the tool in the receiving hole (17). Both clamping forces provide self-tightening feature to the drill chuck and improve the stability and precision thereof. After the tool is clamped tightly, rotating downwardly the locking nut (7) which will force the locking cap (6) to react following the same fashion. The locking pins (61), placed on bottom of said cap (6) compress the locking spring (5), causing its exterior diameter expands. The expansion of the locking spring (5) also pushes the locking ring (91) which is placed on upper end of the outer casing (9), toward the inner wall of the outer casing (9) and prohibits the relative movement between the outer casing (9) and the mandrel (4), locking the drill chuck and allowing clockwise and counterclockwise rotations of the drill chuck.

A loading hole (13) is set on the upper portion of said chuck-body (1) where correspond to the position of said first race (14), the diameter of said loading hole (13) is larger than the diameter of said bearing ball (8) and a seal screw (12) is screw jointed to said loading hole (13). During the manufacture, the bottom portion of said mandrel (4) is engaged with the connecting hole (18), aligning the second race (41) with the first race (14). A bearing ball (8) is placed into the chamber formed by the first race (14) and second race (41); rotating the mandrel (4) to next position and places another bearing ball (8). Repeat the above process until the chamber is filled with bearing balls (8), screw joints the seal screw onto the loading hole (13) afterward to avoid detachment of bearing balls (8).

Said groove (31) can also be manufactured as cylindrical shape with one opening, the transversal section thereof approximates as “O” or a horseshoe shape with opening toward downside. The nose of the jaws (2) will be manufactured as spherical to fit in the groove (31).

A V-shaped notch is set on the exterior of each jaw (2) along the axial line thereof, and a latch hole (15) is perforated through the upper end of said chuck-body (1) and reaching the said passage on; a latch (11) is accommodated into said latch hole (15) and the apex of said latch (11) corresponds with said V-shaped notch. The apex matches the V-shaped notch, ensuring that the jaws (2) can only move up/downwardly along the guides (16), avoiding transverse movement inside the guides (16) and improving the stability of the jaws (2). Without processing extra thread on the exterior of the jaws (2), the manufacturing is simplified and the cost is reduced.

The installation of the locking ring (91) allows the outer casing (9) can be manufactured by light-weight, low cost material such as plastic, it reduces the weight, the cost and size of the chuck, expanding the application area thereof.

### Second Embodiment

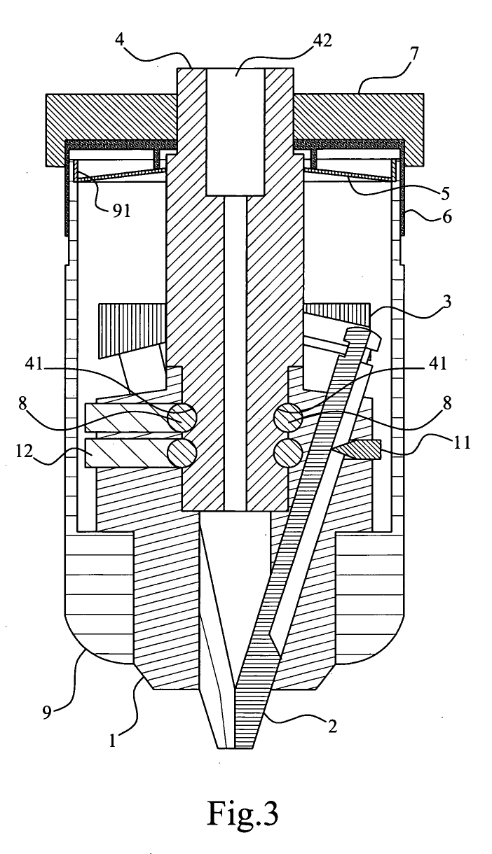

As shown in FIG. 3 is the second embodiment of the present invention. The structure of said embodiment is similar to the first embodiment, with difference that this embodiment includes one more set of first race (14) and second race (41) than the previous embodiment, forming two bearings between the chuck-body (1) and mandrel (4), improving the stability and liability of the chuck.

### Third Embodiment

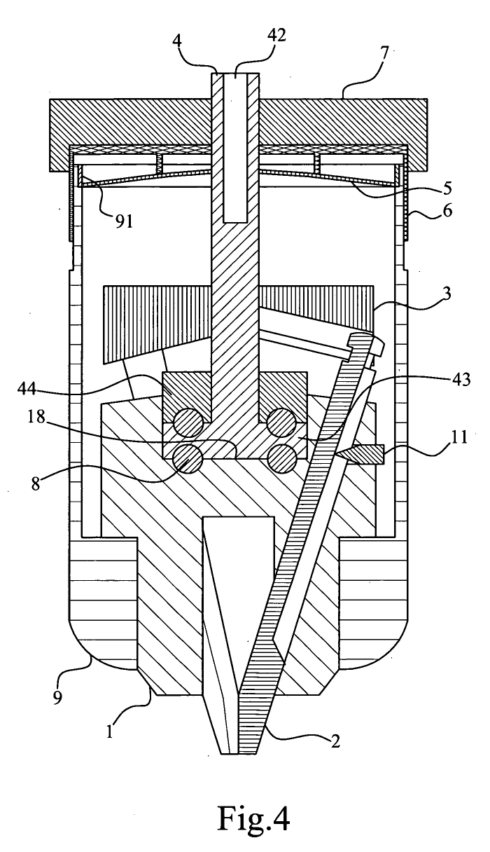

As shown in FIG. 4 is the third embodiment of the present invention, said embodiment consists of a dish (43) on the bottom end of said mandrel (4) and a race is set onto the upper and bottom end of said dish (43) respectively. Said race on the bottom corresponds to another race set onto the inner bottom of said connecting hole (18), forming a circular spherical chamber by coupling both. A cover plate (44), attached onto said mandrel (4) is fixed with the upper end of said chuck-body (1) and coupled with said dish (43). A race set on bottom of the cover plate (44) corresponds to said upper race of the dish (43), forming another circular spherical chamber by jointing both. Both chambers are filled with bearing balls (8). Said bearing balls (8) disclosed in the embodiment can also be replaced by cylindrical metal rods or cones, forming rod bearing or tapered roller bearing. The present embodiment is structurally simpler than what is disclosed in the second and is also provided with feature of easy maintenance for the bearing.

### Forth Embodiment

The forth embodiment (not shown) is a drill chuck suitable for lower cost and requirement. Only one circular raceway is set on the bottom portion of the mandrel (4) and at least three latch holes where correspond to the position of the raceway are set on the upper portion of said chuck-body (1). Three latches are incorporated into said latch holes with the apex inserted into said raceway. This mechanism allows both mandrel (4) and chuck-body (1) to move freely but won't disengage by function of the latches.

In a working environment where the torque is low and no higher clamping force is required, said locking spring (5), locking cap (6), locking nut (7) and locking ring (9) can be optional for reducing the cost of the chuck.

What disclosed above are only the preferred embodiments of the present invention and it is therefore not intended that the present invention be limited to particular embodiment disclosed. It will be understood by those skilled in the art that various equivalent changes may be made depending on specification and drawings of present invention without departing from the scope of the present invention. (20).

Accordingly, the present invention is aimed to provide a frame which is connected by an axle is light and rigid, not to be out of shape.

### SUMMARY OF THE INVENTION

The present invention is to provide a paint roller with tubular frame processed through less contamination process, lower material cost, light weight but durable in use.

The present invention is to provide a paint roller with tubular frame includes, at least, a tubular axle (1); a cylinder (4) at a distal end of said axle (1); and

A handle (3) at a proximal end of said axle (1); characterized in that:

Being processed through roll mill to reel stretch said axle (1) to form bent portions (2), which further processed through stamping machine to lengthen, flatten and bend the bent portions (2), where a cross section of said bent portions (2) shown a width larger than a height shaped in an overall flattened configuration (A).

Said flattened configuration (A) selected from one of the following: a rectangular shaped, an oval shaped, or a diamond shaped.

Said cylinder (4) includes two wheel spacers (7), a first ferrule (5) and a second ferrule (6) disposed adjacent said two wheel spacers (7) respectively to form both ends of said cylinder (4); a plurality of steel wires (8) disposed between said first, second ferrules (5, 6) to shape a cylindrical symmetric hollowed out shaft.

### Advantages of Embodiments of the Invention

1. Selected portions of said tubular axle (1) are processed through reel stretching process by roll mill to lengthen, flatten, and bend said selected portions to form said bent portions (2), which are further processed through stamping process by stamping machine, cross sections of said bent portions is defined as a width larger than a height within a flattened configuration. Tubular axle (1) is therefore light weight and durable in use.

2. Tubular axle (1) carries a weight only ⅓ of a solid axle with a same diameter. Material cost can be saved.

3. To pull and stretch said tubular axle (1) through modes, or to weld said tubular axle (1) one by one, neither acid pickling nor phosphating treatment is required in manufacturing.

4. No other components need to be processed through any treatments to join together to the paint roller with tubular frame. Thereby, the tubular axle can be completely adapted to paint roller instead of old fashioned items.

5. Said tubular axle (1) is used instead of the solid axle (20) of old fashioned paint roller (10). Not only material cost which about ⅔ steel material used on solid axle (20) can be saved; but already lengthen, flatten and bend said tubular axle (1) to form said bent portions (2), which is already shaped into flattened configuration in shape; said cylinder (4) rotates about said tubular axle (1) regularly.

6. When processed and assembled, said tubular axle (1) is superior to said solid axle (20) as following: (a) Said solid axle (20) processed through stamping machine, which is easily damaged by said solid axle (20). While said tubular axle (1) can be stamped flattened in shape. Operational life of the stamping machine can be prolonged. (b) Finished solid axle (20) hooks into a handle (40) by an easily damaged end—to confront the tough handle with portions (2) shown a width larger than a height shaped in an overall flattened configuration (A). (As shown in FIG. 3)

As above, selected portions of said tubular axle (1) are processed through reel stretching process by roll mill to lengthen, flatten, and bend said selected portions to form said bent portions (2), which are further processed through stamping process by stamping machine, cross sections of said bent portions is defined as a width larger than a height within a flattened configuration. Tubular axle (1) is therefore light weight and durable in use.

Further, said tubular axle (1) carries a weight only ⅓ of a solid axle with a same diameter. Material cost can be saved.

Moreover, to pull and stretch said tubular axle (1) through modes, or to weld said tubular axle (1) one by one, neither acid pickling nor phosphating treatment is required in manufacturing.

No other components need to be processed through any treatments to join together to the paint roller with tubular frame. Thereby, the tubular axle can be completely adapted to paint roller instead of old fashioned items.

Said tubular axle (1) is used instead of the solid axle (20) of old fashioned paint roller (10). Not only material cost which about ⅔ steel material used on solid axle (20) can be saved; but already lengthen, flatten and bend said tubular axle (1) to form said bent portions (2), which is already shaped into flattened configuration in shape; said cylinder (4) rotates about said tubular axle (1) regularly.

When processed and assembled, said tubular axle (1) is superior to said solid axle (20) as following: (a) Said solid axle (20) processed through stamping machine, which is easily damaged by said solid axle (20). While said tubular axle (1) can be stamped flattened in shape. Operational life of the stamping machine can be prolonged. (b) Finished solid axle (20) hooks into a handle (40) by an easily damaged end—to confront the tough handle with toughness of solid axle (20). While said tubular axle (1) fits into a handle (3) by a tubular end, which carries only ⅓ weight of said solid axle (20). Where the handle (3) made of plastics tightly fits over the tubular axle (1).

On the whole, the paint roller with tubular frame of the present invention is light weight, durable in use, environmental friendly. That is superior to said old fashioned paint roller (10).

Said flattened configuration (A) selected from one of the following: a rectangular shaped, an oval shaped, or a diamond shaped.

Said cylinder (4) includes two wheel spacers (7), a first ferrule (5) and a second ferrule (6) disposed adjacent said two wheel spacers (7) respectively to form both ends of said cylinder (4); a plurality of steel wires (8) disposed between said first, second ferrules (5, 6) to shape a cylindrical symmetric hollowed out shaft.

1. A frame includes, at least, a tubular axle (1); a cylinder (4) at a distal end of said axle (1); and
a handle (3) at a proximal end of said axle (1); characterized in that: said axle (1) comprising a bent portions (2), where a cross section of said bent portions (2) shown a width larger than a height shaped in an overall flattened configuration (A).

2. The frame of claim 1 wherein said flattened configuration (A) selected from one of the following: a rectangular shaped, an oval shaped, or a diamond shaped.

3. The frame of claim 1 wherein said cylinder (4) includes two wheel spacers (7), a first ferrule (5) and a second ferrule (6) disposed adjacent said two wheel spacers (7) respectively to form both ends of said cylinder (4); a plurality of steel wires (8) disposed between said first, second ferrules (5, 6) to shape a cylindrical symmetric hollowed out shaft.
